(19) United States
(12) Patent Application Publication
(10) Pub. No.: US 2023/0339050 A1
(43) Pub. Date: Oct. 26, 2023

(54) SELF-PROPELLED WELDING MACHINE FOR BUTT WELDING PIPES

(71) Applicant: RITMO S.P.A., Teolo (Padova) (IT)

(72) Inventors: Renzo BORTOLI, Montegrotto Terme (Padova) (IT); Marco DALLA FONTANA, Cervarese Santa Croce (Padova) (IT); Paolo MEGGIORIN, Monselice (Padova) (IT)

(73) Assignee: RITMO S.P.A., Teolo (Padova) (IT)

(21) Appl. No.: 18/301,903

(22) Filed: Apr. 17, 2023

(30) Foreign Application Priority Data
Apr. 21, 2022 (IT) 102022000007880

(51) Int. Cl. B23K 37/053; B25J 5/00; B23K 11/093

(52) U.S. Cl. CPC B23K 37/053; B25J 5/005; B23K 11/0935; B23K 2101/10

(57) ABSTRACT

A self-propelled welding machine for butt welding pipes, comprising a chassis having a traction means which allows its movement along a direction of travel; the chassis supports a welding apparatus comprising a first clamping unit and a second clamping unit, adapted to respectively engage a first tubular element and a second tubular element to be joined by welding; a device for milling the ends of the first and second tubular elements and a heating plate for welding the ends are associated or associable with the welding apparatus; the particularity of the self-propelled welding machine resides in that it comprises at least one first blade associated with a first end of the chassis; the first blade is arranged transversely with respect to the direction of travel and is movable with respect to the chassis.

### 1. FIELD OF THE INVENTION

The present invention relates to a self-propelled welding machine for pipe butt welding.

### 2. DESCRIPTION OF THE PRIOR ART

Various types of apparatus for butt welding plastic pipes are known.

Conventional apparatuses generally comprise a supporting frame having four aligned clamps that, in pairs, lock the end portions of the tubular elements to be welded.

Adapted movement devices allow to move the clamps in such a way as to bring the heads of the tubular elements into contact.

A milling machine for flattening the butts of the tubular elements to be welded, and a heating plate for heating the butts, are associated with the supporting frame.

Generally, such welding apparatuses are also equipped with a hydraulic unit for actuating the various hydraulic components, an electrical unit for powering the electrical devices, and a motor, which may be of various types, internal combustion, electric, or other, that provide the necessary power.

Usually such welding apparatuses are mounted on wheeled trolleys intended to be towed by tractors or, better, are supported by chassis equipped with motorized tracks, which allow their movement around the construction site along the piping being laid out.

Welding machine equipped with a tracked means of locomotion are substantially autonomous, but they are often not very easy to move and maneuver, especially if the terrain on which they must move is uneven, because of differences in elevation to be overcome such as for example bumps or a rough surface, a situation that is not uncommon on a construction site.

The difficulties of maneuvering such self-propelled welding machines over uneven ground can be dangerous both to the safety of the operators, who generally follow the machines on foot as they move, and to the welding machines themselves, should control thereof be lost.

Therefore, in such conditions it is often necessary to carry out a preventive leveling of the ground, using mechanical shovels, graders, excavators or similar works vehicles, with consequent increased time and costs.

Moreover, it should be noted that the tracks of self-propelled welding machines are subjected to considerable mechanical stress, and it is not uncommon for them to be damaged to such an extent that they require replacement.

In such cases, it is necessary to replace the deteriorated tracks with other new ones, but this usually requires the use of additional equipment that allows to lift the self-propelled welding machine off the ground.

This results in increases in the costs for maintenance and/or part replacement of self-propelled welding machines, for which harmful and unforeseen temporary suspensions of welding operations may also occur.

### OBJECTS OF THE INVENTION

The aim of the present invention is to provide a self-propelled welding machine for pipe butt welding that overcomes the drawbacks of the cited prior art.

Within the scope of this aim, a particular object of the invention is to provide a self-propelled welding machine that can be moved along the path of the piping, conveniently and quickly, in complete safety for the operator assigned to its operation, even in case of rough terrain.

A further object of the invention is to provide a self-propelled welding machine that can be placed on the construction site conveniently and precisely in the welding positions, compensating for any inclination of the ground so as to facilitate the correct alignment of the pipes to be welded.

A further object of the invention is to provide a self-propelled welding machine that facilitates routine and extraordinary maintenance operations, such as for example the replacement of the tracks in case of wear or deterioration that has impaired their functionality.

### SUMMARY OF THE INVENTION

The above aims, and other aims that will become apparent to those skilled in the art, are achieved by a self-propelled welding machine for pipe butt welding, as claimed in the appended claims.

Further characteristics and advantages of the invention will become apparent from a reading of the detailed description of a preferred but not exclusive embodiment of a self-propelled welding machine for pipe butt welding, according to the invention, illustrated only by way of a non-limiting example in the accompanying drawings.

### BRIEF DESCRIPTION OF THE DRAWINGS

FIG. 1 is a perspective view of a self-propelled welding machine according to the invention, on which two tubular elements are loaded;

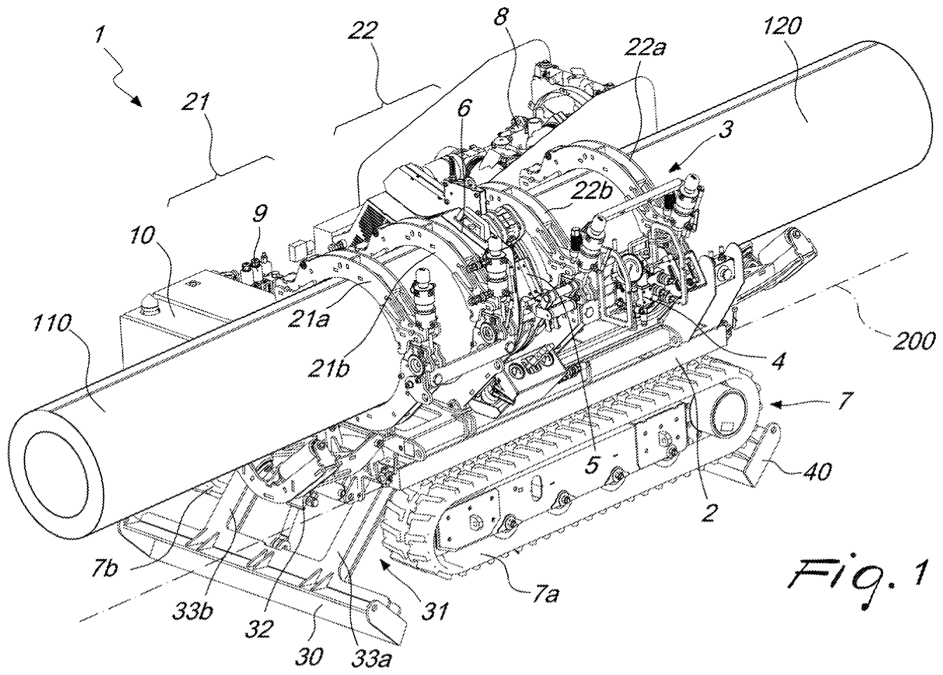

FIG. 2 is a perspective view from below of the self-propelled welding machine according to the invention;

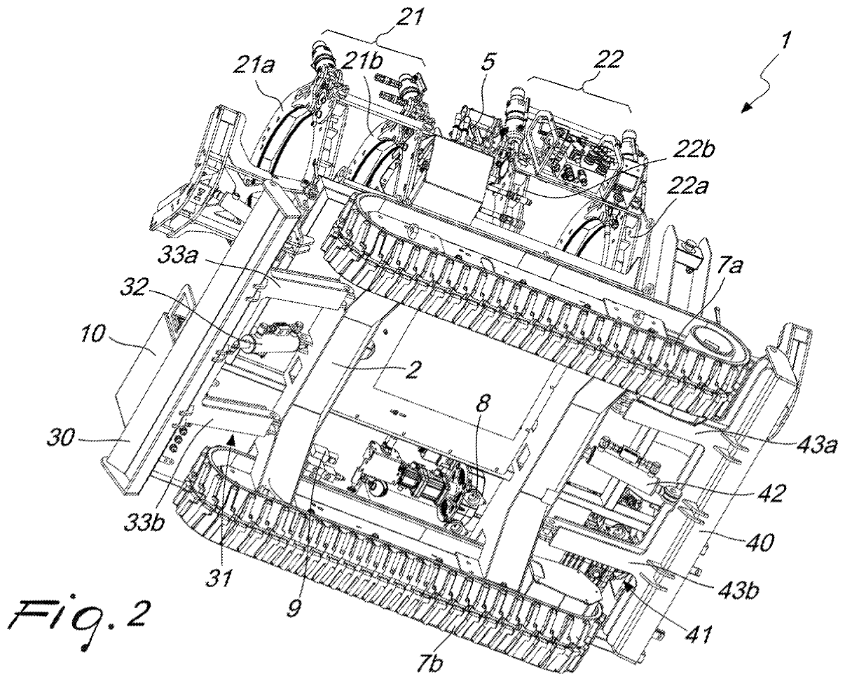

FIG. 3 is a side view of the self-propelled welding machine according to the invention, on which two tubular elements are loaded;

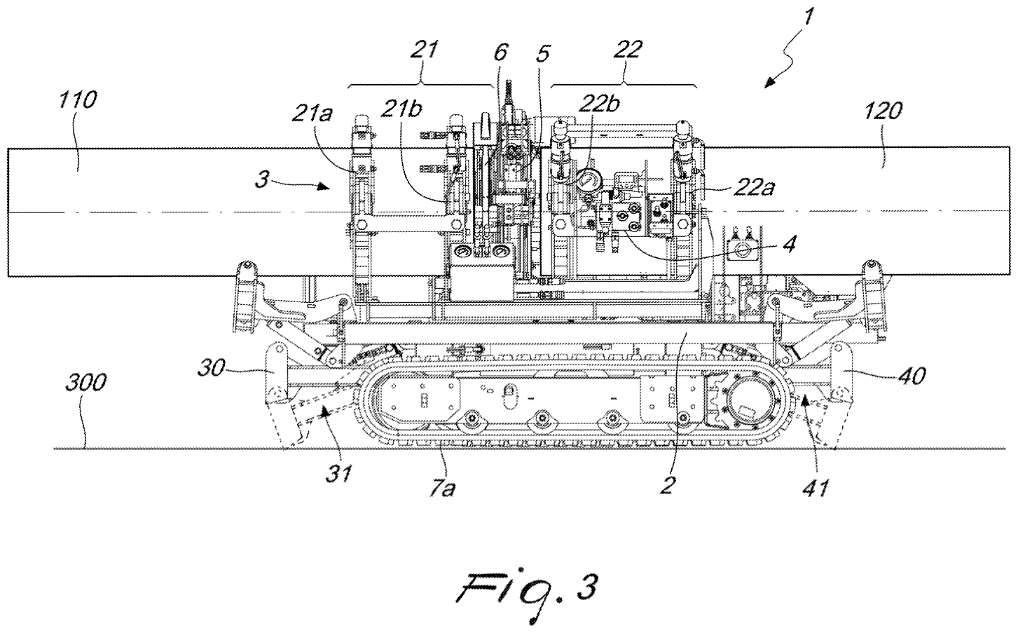

FIG. 4 is a side view of the self-propelled welding machine according to the invention, arranged on inclined ground, on which two tubular elements are loaded;

FIG. 5 is a side view of the self-propelled welding machine according to the invention, on which two tubular elements are loaded which are inclined with respect to the ground;

FIG. 6 is a side view of the self-propelled welding machine according to the invention, raised above the ground;

FIG. 7 is a side view of the self-propelled welding machine according to the invention, used to grade the ground.

### DESCRIPTION OF THE PREFERRED EMBODIMENTS OF THE INVENTION

With reference to the figures, a self-propelled welding machine for pipe butt welding is generally designated by the reference numeral 1.

The self-propelled welding machine 1 has a chassis 2 which supports a welding apparatus 3, of a per se known type, constituted in the specific case by a first clamping unit 21 and a second clamping unit 22 that respectively engage a first tubular element 110 and a second tubular element 120 to be joined by polywelding.

In this embodiment, both the first clamping unit 21 and the second clamping unit 22 are composed of two pairs of jaws, that are mutually integral and spaced apart, 21a, 21b and 22a, 22b, respectively.

The second clamping unit 22 moves toward/away from the first clamping unit 21 by means of an actuator, not shown in the figures, which is constituted for example by hydraulic cylinders actuated by a control device 4.

The welding apparatus 3 also has a milling device 5, adapted to flatten and render parallel the ends of the first and second tubular elements 110, 120, and a heating plate 6, suitable for melting the ends after flattening.

Both the milling device 5 and the heating plate 6 are removably associated with the welding apparatus 3 and can be moved with respect to the first and second clamping units 21, 22.

The chassis 2 has a traction means 7 that allows its bidirectional movement along a direction of travel 200.

Preferably, the traction means 7 has a pair of tracks 7a, 7b, arranged on the left and right sides of chassis 2, respectively.

Advantageously, tracks 7a, 7b can be driven independently of each other, for example, by means of hydraulic motors powered by a pump driven by a motor means 8 with which the self-propelled welding machine 1 is equipped, or by means of electric motors managed by a control system.

In practice, tracks 7a, 7b can have a coincident motion, i.e., both forward or both in reverse, or a differential motion, i.e., one forward and the other in reverse or one forward and the other stationary.

According to a further embodiment, not shown in the figures, the traction means 7 has wheels arranged on the sides of the chassis 2, or a combination of wheels and tracks.

In the example shown here, the motor means 8 is an internal combustion engine; alternatively the motor means may be an electric motor.

The chassis 2 also supports a hydraulic unit 9, for actuating the various hydraulic components that equip the self-propelled welding machine 1, and an electrical unit 10 for powering the various electrical components.

The welding apparatus 3 may be advantageously provided with different constructive characteristics with respect to those so far described and illustrated by way of example, without thereby departing from the scope of the invention, as will become apparent to the person skilled in the art.

According to the present invention, the self-propelled welding machine 1 has at least a first blade 30 connected to one of the two opposite ends of the chassis 2, in the specific case the front end.

The first blade 30, which is movable with respect to the chassis 2, is arranged transversely with respect to the direction of travel 200.

In the embodiment shown in the figures, the self-propelled welding machine 1 also has a second blade 40 which is connected to the other end of the chassis 2, constituted in the specific case by the rear end.

The second blade 40 is movable with respect to the chassis 2 and is arranged transversely with respect to the direction of travel 200.

Here, the expression “blade” generally refers to a variously shaped metal plate, suitable in particular for moving earth, crushed stone or inert materials, or for performing other construction site work.

The first and second blades 30, 40 are each provided with lifting/lowering means, respectively designated with the reference numerals 31 and 41. The lifting/lowering means allow to change the height of the blades 30, 40 with respect to the ground 300, independently of each other.

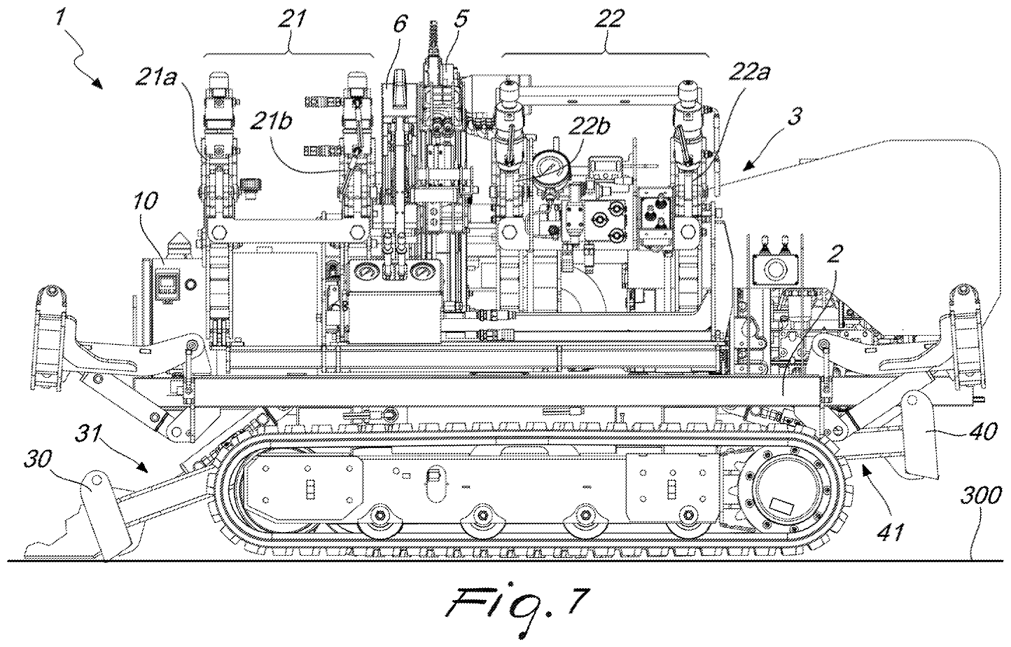

Each blade 30, 40 can therefore be brought to a unique height above the ground 300, for example, to level in a substantially uniform manner any localized depressions or accumulations of material, as shown by way of example in FIG. 7.

Advantageously, the lifting/lowering means 31, 41 allow the first and second blades 30, 40 to evenly protrude beyond the plane defined by the tracks 7a, 7b in a lower region.

Consequently, by properly actuating the lifting/lowering means 31, 41, it is possible to raise the entire self-propelled welding machine 1 whereby the lower plane of the tracks 7a, 7b is above the ground 300.

The combination of the above characteristic with the possibility of independently adjusting the height from the ground 300 of the first and second blades 30, 40 advantageously offers excellent flexibility of use of the self-propelled welding machine 1.

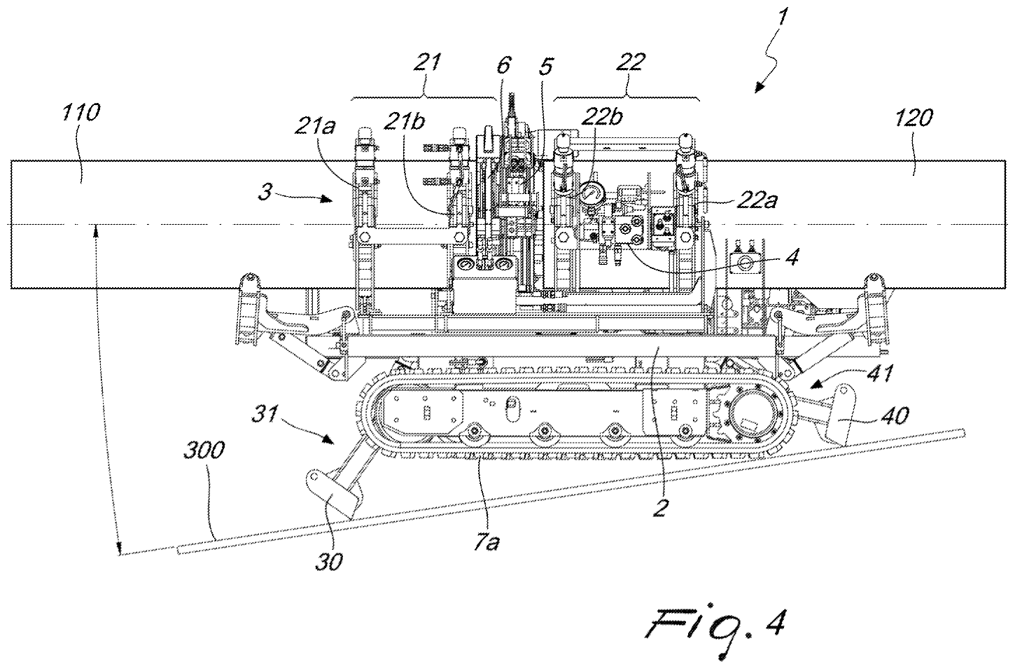

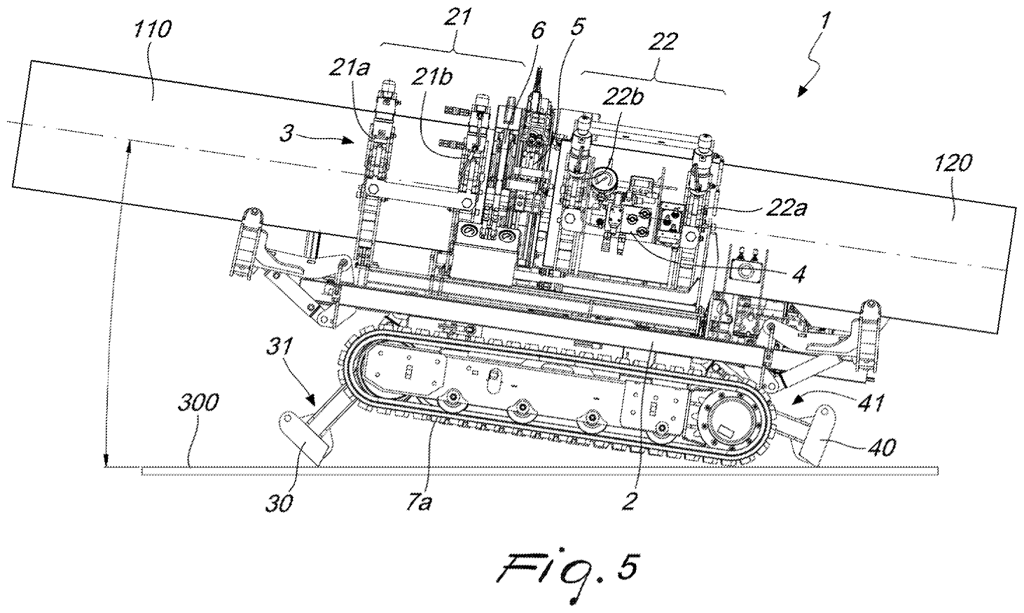

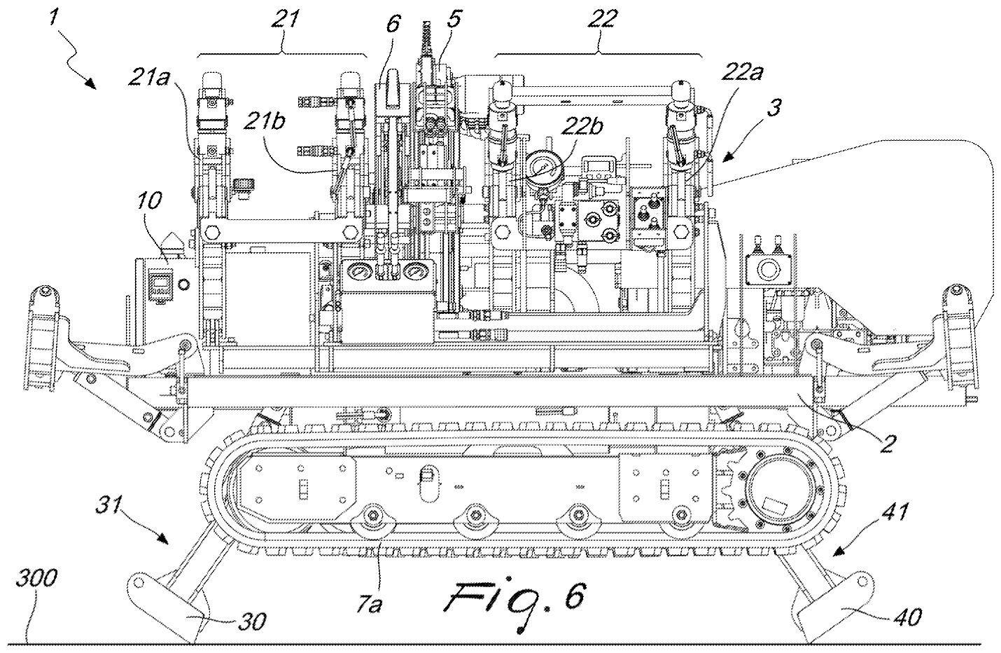

In fact, in addition to what has already been described, the two blades 30, 40 allow, for example, to adjust the inclination of the first and second tubular elements 110, 120 with respect to the ground 300, as shown by way of example in FIGS. 4 and 5, or to raise the self-propelled welding machine 1 completely with respect to the ground 300, as shown by way of example in FIG. 6, for example to facilitate some maintenance operations, such as the replacement of one or both tracks 7a, 7b.

Also, the two blades 30, 40, if positioned appropriately, can be used to ensure and increase the stability of the self-propelled welding machine 1 by transferring the forces to the ground 300.

Namely, the lifting/lowering means 31, 41 have a first linear actuator 32 which is pivoted at a first end thereof to a portion of the first blade 30 and at the other end thereof to the chassis 2, and a second linear actuator 42 which is pivoted at a first end thereof to a portion of the second blade 40 and at the other end thereof to the chassis 2.

Each linear actuator 32, 42 may consist, for example, of a hydraulic cylinder connected to the hydraulic unit 9 and appropriately controlled by a control unit.

The first linear actuator 32 is assisted by a first pair of arms 33a, 33b, which are integral with the first blade 30 at one end and are hinged to the chassis 2 at the other end.

Likewise, the second linear actuator 42 is assisted by a second pair of arms 43a, 43b, which are integral with the second blade 40 at one end and are hinged to the chassis 2 at the other end.

The first and second blades 30, 40 may also be tilted with respect to the direction of travel 200 of the self-propelled welding machine 1, by means of an angular displacement means, not shown in the figures.

The operation of the self-propelled welding machine according to the invention is substantially as follows.

For example, if the self-propelled welding machine 1 needs to move and operate on uneven ground, it is possible to take advantage of the first blade 30, or the second blade 40, depending on the direction of travel of the machine, to grade the ground so as to obtain a substantially flat surface, as shown by way of example in FIG. 7.

The first and second blades 30, 40 may also be used to change the inclination of the first and second tubular elements 110, 120 with respect to the ground 300, for example, if it is necessary to level the tubular elements 110, 120 on sloping ground 300, as illustrated by way of example in FIG. 4, or if the ground 300 is level and the two tubular elements 110 and 120 must be inclined, as illustrated by way of example in FIG. 5.

Another form of advantageous use of the first and second blades 30, 40 relates to the possibility of using them to lift the self-propelled welding machine 1 completely off the ground 300, for example to facilitate some cleaning or maintenance work, such as replacing one or both of the tracks 7a, 7b, as illustrated by way of example in FIG. 6.

Also, the two blades 30, 40 can be used to ensure and increase the stability of the self-propelled welding machine 1.

In practice it has been found that the invention achieves the intended aim and object, providing a self-propelled welding machine that can be moved along the path of the piping formed by pipes to be welded conveniently and quickly, in full safety for the operator assigned to its operation, even in case of rough terrain.

A further advantage of the self-propelled welding machine according to the invention is that it can be positioned at the construction site conveniently and precisely in the welding positions, compensating for any inclination of the ground so as to facilitate the leveling of the pipes to be welded or of the welding machine itself.

Also, the self-propelled welding machine according to the invention facilitates routine and extraordinary maintenance operations, such as for example the replacement of tracks in case of wear or deterioration that has compromised their functionality.

This application claims the priority of Italian Patent Application No. 102022000007880, filed on Apr. 21, 2022, the subject matter of which is incorporated herein by reference.

1. A self-propelled welding machine for butt welding pipes, comprising a chassis and a traction means associated with said chassis; said traction means allowing a movement of the machine along a direction of travel; said chassis supporting a welding apparatus comprising a first clamping unit and a second clamping unit, adapted to respectively engage a first tubular element and a second tubular element to be joined by welding; a device for milling the ends of said first and second tubular elements and a heating plate for welding said ends being associated with said welding apparatus; said self-propelled welding machine further comprising at least a first blade associated with a first end of said chassis; said first blade being arranged transversely with respect to said direction of travel and being movable with respect to said chassis.

2. The self-propelled welding machine, according to claim 1, comprising a second blade associated with a second end of said chassis and opposite to said first end; said second blade being arranged transversely with respect to said direction of travel and being movable with respect to said chassis.

3. The self-propelled welding machine, according to claim 2, comprising means for lifting/lowering said first and second blades with respect to the ground.

4. The self-propelled welding machine, according to claim 3, wherein said lifting/lowering means comprise a first linear actuator which is pivoted, at one of its ends, to a portion of said first blade and, at its other end, to said chassis, and a second linear actuator which is pivoted, at one of its ends, to a portion of said second blade and, at its other end, to said chassis.

5. The self-propelled welding machine, according to claim 3, wherein said lifting/lowering means comprise first arms which, at one end, are integral with said first blade and, at the other end, are articulated to said chassis, and second arms which, at one end, are integral with said second blade and, at the other end, are articulated to said chassis.

6. The self-propelled welding machine, according to claim 2, comprising a means for the angular movement of said first and second blades with respect to said direction of travel.

7. The self-propelled welding machine, according to claim 1, wherein said traction means comprises a pair of tracks arranged on opposite sides of said chassis; said tracks being driven independently of each other by a motor means mounted on said chassis.

8. The self-propelled welding machine, according to claim 1, wherein said traction means comprises wheels arranged on opposite sides of said chassis; at least some of said wheels being actuated by a motor means mounted on said chassis.

9. The self-propelled welding machine, according to claim 1, comprising a hydraulic unit mounted on said chassis for the actuation of hydraulic components equipped to said self-propelled welding machine.

10. The self-propelled welding machine, according to claim 1, comprising an electrical unit mounted on said chassis; said electrical unit powering electrical components equipped to said self-propelled welding machine.
